(19) United States
(12) Patent Application Publication
(10) Pub. No.: US 2005/0046084 A1
(43) Pub. Date: Mar. 3, 2005

(54) Method and apparatus for producing multicoloured concrete blocks

(75) Inventor: Roland Krause, Burbach (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hess Maschinenfabrik GmbH & Co. KG, Burbach-Wahlbach (DE)

(21) Appl. No.: 10/911,163

(22) Filed: Aug. 3, 2004

(30) Foreign Application Priority Data
Aug. 26, 2003 (DE) 10339143.6

(51) Int. Cl. B28B 3/00

(52) U.S. Cl. 264/333; 425/258

(57) ABSTRACT

The invention relates to a method and an apparatus for producing multicoloured concrete blocks, in which coloured concrete mortar is poured from a silo into a receiving space of a filling carriage, the filling carriage is traversed across a moulding tool for the concrete blocks, and the moulding tool is filled with concrete mortar from the filling carriage, after which the filling carriage is returned and the concrete mortar located in the moulding tool is compacted, differently coloured concrete mortar being poured into at least one additional receiving space of the filling carriage and being introduced into the moulding tool via at least one distributing roller rotationally driven in accordance with a predetermined discharge.

### FIELD OF THE INVENTION

The invention relates to a method and an apparatus for producing multicoloured concrete blocks, for instance concrete blocks mainly of concrete which is not provided with additional colouring pigments and provided with a surface layer of a concrete material coloured by the addition of pigments so that the surface which is visible later on has a desired colour like red or green or any other colour.

### DESCRIPTION OF THE RELATED ART

It is known from German Patent DE 198 27 104 C2 to produce concrete blocks, for instance paving blocks, by first of all forming a basic body of coarse concrete which is provided with a covering, multicoloured facing layer of concrete mortar. In this case, the coarse concrete is poured into a moulding tool and compacted in the moulding tool by vibration and/or pressing. The space then remaining is filled with concrete mortar, which is likewise compacted. In this case, provision is made for various coloured layers to be arranged one above the other in a container in order to form the facing layer, parts of said layers falling downwards at the same time and striking a baffle, after which they are directed along a deflection curve, mixed with one another and applied to the coarse concrete as multicoloured concrete mortar, where the concrete mortar forms a marbled facing layer. However, this has the disadvantage that the initial layers can already mix in an uncontrolled manner in the container and subsequently on their way into the moulding tool. This gives rise to a problem if, for example, surfaces which have already been paved are to be widened; the concrete blocks then cannot be reproduced in the correct colour.

In order to improve the reproducibility of coloured concrete blocks, it is known from German Utility Model DE 299 04 566 U1, instead of concrete-mortar layers of different colouring in one container, to use a plurality of silos located side by side for in each case a concrete mortar having uniform colouring, it being possible for the silos to be opened at the bottom end independently of one another, so that the concrete mortar can be received by a filling carriage, from which it passes into the moulding tool. Apart from the fact that this leads to increased mechanical complexity, uncontrolled mixing of differently coloured concrete mortar may occur in the filling carriage when pouring takes place and when the filling carriage travels back and forth. In addition, the cycle times are relatively short, since the displacement speed of the filling carriage has to be kept relatively low in order to avoid the inclination for mixing.

It is known from U.S. Pat. No. 3,955,907 to provide a distributor consisting of two chambers for concrete mortar of different grain size, the concrete mortar being poured from the chambers into a traversable filling carriage and being traversed with the latter across the moulding tool in order to fall into the latter. The chambers of the distributor are arranged one behind the other in the displacement direction of the filling carriage, the rear chamber being lengthened in the centre region down below the front chamber and being open at the bottom there, a screw conveyor which extends in the displacement direction being provided in this lengthened section in order to pour concrete mortar from the rear chamber into the centre region of the filling carriage. This is intended to produce a three-layer block structure which is then divided centrally in order to obtain two blocks which each have a fine-grained surface. The fine-grained centre layer is to be of relatively thick design, since intermixing with the coarse-grained material cannot be avoided, especially since two free dropping sections are provided.

### SUMMARY OF THE INVENTION

It is an object of the invention to provide a method of producing concrete blocks, which enables multicoloured concrete blocks to be reproduced without considerable mechanical complexity.

It is a further object of the invention to provide an apparatus for producing concrete blocks having a relatively simple construction and at the same time allows multicoloured concrete blocks to be reproduced.

Thus, the invention concerns a method of producing concrete blocks, comprising:
providing a filling carriage having a first and at least a second receiving space and being transversable between a position under a silo and a position above a moulding tool;
pouring concrete mortar of a first colour from the silo into the first receiving space of the filling carriage and concrete mortar of different colour into the second receiving space of the filling carriage;
transversing the filling carriage across the moulding tool for the concrete blocks;
filling the moulding tool with concrete mortar from the filling carriage under introducing the concrete mortar from the second receiving space onto the concrete mortar of the first receiving space by means of at least one distributing roller rotationally driven in accordance with a predetermined discharge and extending transversely to the displacement stroke of the filling carriage;
returning the filling carriage; and
compacting the concrete mortar located in the moulding tool.

The invention further concerns an apparatus for producing concrete blocks, comprising:
a silo, moulding tool for the concrete blocks and a filling carriage which is open at the bottom and displaceable over a table top between a position under the silo and a position above the moulding tool,
wherein the silo is subdivided into at least two receiving spaces for concrete mortar transversely to the displacement stroke of the filling carriage by at least one partition wall, each of said receiving spaces being provided with an underside closable outlet,
and wherein the filling carriage is subdivided transversely to its displacement stroke into a corresponding number of correspondingly arranged receiving spaces, which are open at the bottom and of which at least one is provided with a drivable distributing roller extending transversely to the displacement stroke of the filling carriage.

For producing multicoloured concrete blocks, by virtue of the fact that coloured concrete mortar is poured from a silo into a filling carriage, that the filling carriage is traversed across a moulding tool for the concrete blocks, and that the moulding tool is filled with concrete mortar from the filling carriage, after which the filling carriage is returned and the concrete mortar located in the moulding tool is compacted, concrete mortar of a different colour being poured into at least one additional receiving space of the filling carriage and being introduced into the moulding tool via at least one distributing roller rotationally driven in accordance with a predetermined discharge, this makes it possible for multicoloured concrete blocks to be reproduced in the correct colour with a very high degree of accuracy without uncontrollable mixing of the various coloured concrete mortar masses occurring. By the corresponding data being stored, it is then readily possible, for instance for widening paved areas, for paving blocks matching in colour to also be subsequently produced for this purpose.

Since slightly moist concrete mortar is used for producing concrete blocks, the distributing roller virtually seals off the outlet of the additional receiving space of the filling carriage towards the bottom. However, by rotation of the distributing roller, the slightly moistened concrete mortar located above it is conveyed downwards into the moulding tool, to be precise in accordance with the rotary speed of the distributing roller, which can accordingly be controlled as a function of the displacement stroke of the filling carriage, which displacement stroke can be measured as such and used as control variable, and in accordance with the travel speed and the travel direction of the filling carriage.

The mechanical complexity is relatively low, and the machine frame, the silo and the filling carriage remain unchanged in size and are merely subdivided, i.e. the silo is subdivided into at least two receiving spaces for concrete mortar at least in the direction of the displacement stroke of the filling carriage by at least one partition wall, these receiving spaces each being provided with an underside closable outlet, the filling carriage being subdivided in the direction of its displacement stroke into a corresponding number of receiving spaces, which are open at the bottom and of which at least one has on the outlet side a drivable distributing roller.

All the receiving spaces, or specifically selected receiving spaces, of the filling carriage may be provided on the outlet side with a distributing roller, if appropriate with a common distributing roller. In the case of separate distributing rollers, they may also be operated at a different rotary speed. The distributing rollers may be provided in such a way as to be rotatable in both directions.

Further objects, advantages and modifications of the invention can be gathered from the following description and the claims.

The invention will be explained in more detail below with reference to exemplary embodiments shown in the attached drawings.

### BRIEF DESCRIPTION OF THE DRAWINGS

FIG. 1 shows a schematic detail of an apparatus for producing multicoloured concrete blocks according to the invention in side view and partly in cutaway section.

FIG. 2 shows a filling carriage of the apparatus of FIG. 1 in an enlarged view.

FIGS. 3a to 3c schematically show various means of subdividing the silo of the apparatus of FIG. 1, in plan view.

FIG. 4 shows an arrangement of two distributing rollers of the apparatus of FIG. 1.

FIGS. 5a to 5d show details of different embodiments of a distributing roller of the apparatus of FIG. 1.

### DESCRIPTION OF THE PREFERRED EMBODIMENT

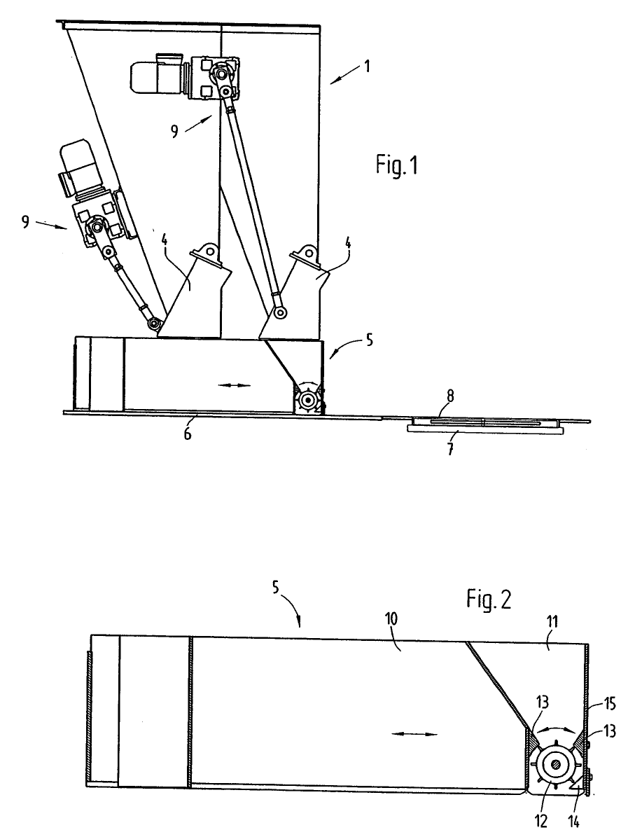

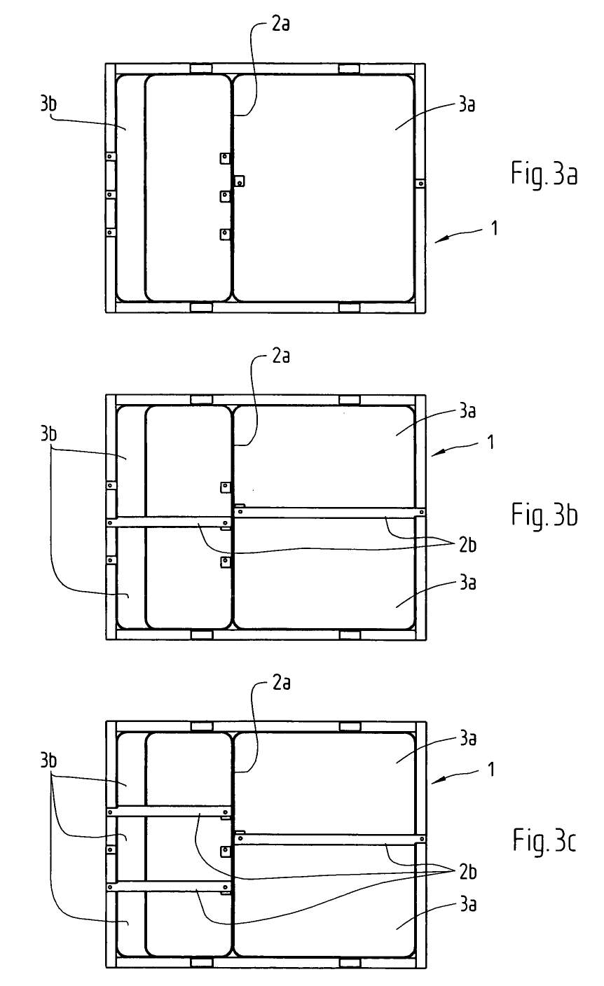

The apparatus shown in FIG. 1 for producing multicoloured concrete blocks comprises a silo 1 which, as shown in FIGS. 3a to 3c, is subdivided by vertical partition walls 2a, 2b into various receiving spaces 3a, 3b tapering downwards in a funnel shape.

Thus, in the simplest case of FIG. 3a, there is a partition wall 2a and two receiving spaces 3a, 3b arranged one behind the other and having the same size or—as shown—a different size. According to FIG. 3b, the two receiving spaces 3a, 3b of FIG. 3a are subdivided once more by partition walls 2b running perpendicularly to the partition wall 2a. The receiving spaces 3a and 3b, respectively, which are formed adjacent to the partition wall 2a as a result, are of the same size or—as shown—of different size. According to FIG. 3c, three receiving spaces 3b are provided side by side, which may likewise be of the same size or of different size. Other divisions are possible.

Each receiving space 3a, 3b serves to receive a concrete mortar of a different colour, so that the masses of concrete mortar or different colour can be received in such a way as to be separated from one another according to colour.

On the underside, the receiving spaces 3a, 3b have a pivotable flap 4 which is linked to the silo 1 and is intended for opening the receiving spaces 3a and 3b, respectively, towards a filling carriage 5 which is open at the top and bottom and can be traversed over a table top 6 between a position under the outlet of the silo 1 and a position above a moulding tool 8, located on a production base 7, for the concrete blocks. The flaps 4 can be pivoted into an open position, for example in each case via a hydraulic or—as shown—electric-motor-operated drive 9 comprising a linkage, so that slightly moist concrete mortar contained in the receiving spaces 3a, 3b can fall into the filling carriage 5.

In the embodiment shown, the filling carriage 5 is conceived for a silo 1 having a subdivision according to FIG. 3a, according to which a larger receiving space 3a and a smaller receiving space 3b are arranged one behind the other in the displacement direction of the filling carriage 5 (the receiving spaces 3a and 3b serve to receive differently coloured masses of concrete mortar, for example red- and yellow-coloured masses). Accordingly, the filling carriage 5 has a larger receiving space 10 and a smaller receiving space 11 one behind the other in its displacement direction. By the corresponding flaps 4 being opened, the concrete mortar, separated in terms of colour, passes into the receiving spaces 10, 11 of the filling carriage 5.

In the embodiment shown of the filling carriage 5, the receiving space 11 is designed to be smaller than the receiving space 10 and is formed in a funnel shape towards a distributing roller 12 arranged at the bottom in the receiving space 11. The distributing roller 12 runs with its axis transversely to the direction of movement of the filling carriage 5 and virtually seals off the receiving space 11 towards the bottom.

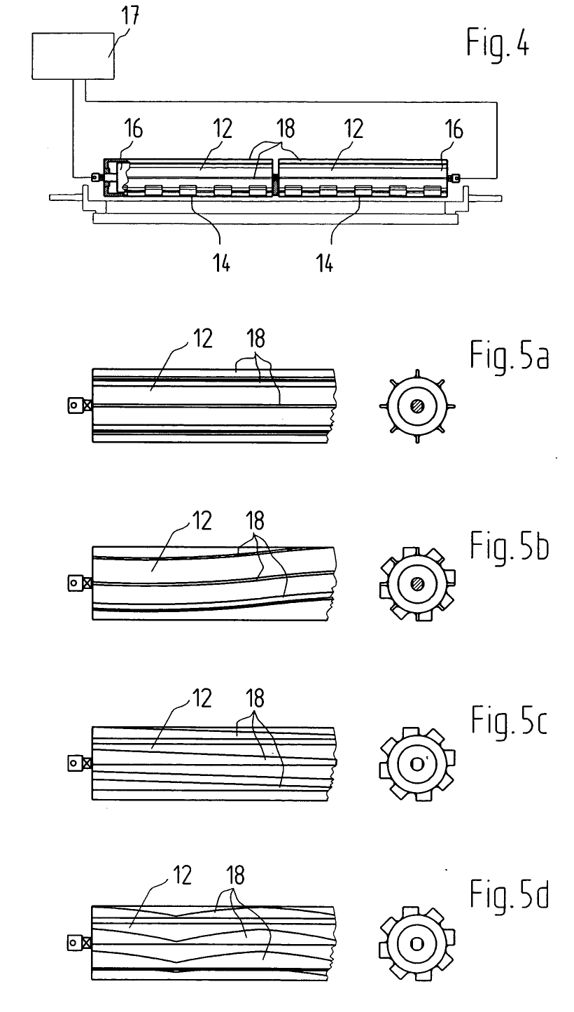

The feed region for concrete mortar towards the distributing roller 12 is expediently narrowed further in a funnel shape by corresponding strips 13 extending in the axial direction of the distributing roller 12 and arranged above the distributing roller 12. A strip 14 narrowing the outlet region of the receiving space 11 may also be provided continuously or in sections below the distributing roller 12 on one side or on both sides in the axial direction of the distributing roller 12 (cf., in particular, FIG. 4). Furthermore, it is expedient if the receiving space 11 has a separate housing 15 which can be fastened to the remaining part of the filling carriage 5, so that this housing 15 is interchangeable.

The receiving space 10 may also be provided with one or more distributing rollers 12 running transversely with their axes to the direction of movement of the filling carriage 5; i.e. the individual receiving spaces 10, 11 of the filling carriage 5 may have separate distributing rollers 12. In the exemplary embodiment shown, however, the receiving space 10 is simply open towards the table top 6.

If the silo 1 is subdivided further by partition walls 2b, the receiving spaces 10, 11 of the filling carriage 5 may also be correspondingly subdivided by partition walls extending in the displacement direction of the latter, in which case the receiving spaces 10, 11 which are adjacent transversely to the displacement stroke of the filling carriage 5 may have a separate or a common distributing roller 12. However, it is also possible and preferable for no partition walls corresponding to the partition walls 2b of the silo 1 to be provided in the filling carriage 5, so that a transition region between correspondingly adjacent colours is obtained as a result of mixing when the coloured concrete mortars pass into the filling carriage 5 after the common flap 4 for the receiving spaces 3a has been opened. Nonetheless, distributing rollers 12 separated in accordance with the subdivision of the silo 1 may also be provided in this case transversely to the displacement stroke of the filling carriage 5 for concrete mortars of each of the colours provided, although a common distributing roller 12 is then preferred for this purpose.

The distributing roller 12 or each distributing roller 12 is provided with a drive 16 which is expediently operated by electric motor and is coupled to a corresponding control 17. In particular, a drive 16 lying inside the distributing roller 12 is used in this case for reasons of space.

Since concrete mortar slightly moistened for producing the concrete blocks is used, the distributing roller 12 virtually seals off the outlet of the additional receiving space 11 of the filling carriage 5 towards the bottom. However, by rotation of the distributing roller 12, the slightly moistened concrete mortar located above it is conveyed downwards into the moulding tool 8, when the filling carriage 5 is located above the moulding tool 8. This takes place in accordance with the rotary speed and direction of rotation of the distributing roller 12, which can accordingly be controlled as a function of the displacement stroke of the filling carriage 5 (i.e. of the position of the filling carriage 5 relative to the moulding tool 8), which displacement stroke can be measured as such and used as control variable.

In the exemplary embodiment shown, the concrete mortar contained in the receiving space 11 and having a certain colour is applied in a controlled manner in accordance with the rotary speed and direction of rotation of the distributing roller 12 and in accordance with the travel speed of the filling carriage 5, in particular during the return travel of the filling carriage 5, after the moulding tool 8 has been filled beforehand from the receiving space 10 with concrete mortar having a different colour, so that a predetermined colour pattern is obtained. However, if appropriate, corresponding concrete mortar can be introduced by means of the distributing roller even during the outward travel.

Until the differently coloured concrete mortars have been introduced into the moulding tool 8, the said concrete mortars are received separately from one another in the filling carriage 5, so that to this extent they cannot intermix.

The moulding tool 8 is first of all expediently filled with coarse concrete by means of a further filling carriage, this coarse concrete being compacted in the moulding tool 8 by vibration and/or pressing, after which a facing layer of coloured concrete mortar is applied by means of the filling carriage 5, it being possible for this facing layer to already be pre-compacted during the application. The concrete blocks are then demoulded by being held down by means of a plunger and by the moulding tool 8 being raised, so that the concrete blocks formed remain on the production base 7.

Layers arranged one above the other of differently coloured masses of concrete mortar may also be introduced into the receiving spaces 3a and/or 3b, as a result of which mixed colours can be obtained in intermediate regions.

As can be seen in FIG. 5a, the distributing roller 12 may have continuous webs 18 which extend in the axial direction over the entire length of the distributing roller 12, are arranged at a distance from one another, are uniformly distributed over the circumference of the distributing roller 12, extend outwards, carry along the concrete mortar located above them and correspondingly distribute it over the moulding tool 8.

As shown in FIG. 5b, however, the webs 18 may also run helically along the circumference of the distributing roller 12. As shown in FIG. 5c, the webs 18 are fastened axially to the distributing roller 12, the webs 18 being designed to widen out in their thickness in the axial direction, i.e. being designed axially in a wedge shape. As shown in FIG. 5d, the webs 18 are of wavelike design in their width in the axial direction, one side of the webs 18 being straight and the other being wavy in the exemplary embodiment shown, so that a corresponding wavelike change in thickness of the length of the webs 18 is obtained.

The radial extent of the webs 18 is uniform.

As shown in FIG. 4, the distributing rollers 12 arranged adjacently and coaxially to one another may also be fitted differently with webs 18.

Although the foregoing has been a description of preferred embodiments of the invention, it will be apparent to those skilled in the art that numerous variations and modifications may be made in the invention without departing from the scope as described herein.

1. A method of producing concrete blocks, comprising:
providing a filling carriage having a first and at least a second receiving space and being transversable between a position under a silo and a position above a moulding tool;
pouring concrete mortar of a first colour from the silo into the first receiving space of the filling carriage and concrete mortar of different colour into the second receiving space of the filling carriage;
transversing the filling carriage across the moulding tool for the concrete blocks;
filling the moulding tool with concrete mortar from the filling carriage under introducing the concrete mortar from the second receiving space onto the concrete mortar of the first receiving space by means of at least one distributing roller rotationally driven in accordance with a predetermined discharge and extending transversely to the displacement stroke of the filling carriage;
returning the filling carriage; and
compacting the concrete mortar located in the moulding tool.

2. The method according to claim 1, wherein the at least one distributing roller is rotated during the return motion of the filling carriage.

3. The method according to claim 1, wherein the rotary speed of the distributing roller is controlled as a function of the displacement stroke of the filling carriage.

4. The method according to claim 1, wherein the rotary speed of the distributing roller is controlled as a function of the displacement speed of the filling carriage.

5. The method according to claim 1, wherein differently coloured layers of concrete mortar are arranged in at least one receiving space of the silo.

6. The method according to claim 1, wherein the moulding tool is first of all filled with coarse concrete, which is compacted, after which the moulding tool is filled with coloured concrete mortar.

7. An apparatus for producing concrete blocks, comprising:
a silo, moulding tool for the concrete blocks and a filling carriage which is open at the bottom and displaceable over a table top between a position under the silo and a position above the moulding tool,
wherein the silo is subdivided into at least two receiving spaces for concrete mortar transversely to the displacement stroke of the filling carriage by at least one partition wall, each of said receiving spaces being provided with an underside closable outlet, and
wherein the filling carriage is subdivided transversely to its displacement stroke into a corresponding number of correspondingly arranged receiving spaces, which are open at the bottom and of which at least one is provided with a drivable distributing roller extending transversely to the displacement stroke of the filling carriage.

8. The apparatus according to claim 7, wherein the silo is additionally subdivided in the direction of the displacement stroke of the filling carriage by at least one partition wall.

9. The apparatus according to claim 7, wherein the distributing roller is drivable as a function of the displacement stroke of the filling carriage.

10. The apparatus according to claim 7, wherein the distributing roller is drivable as a function of the displacement speed of the filling carriage.

11. The apparatus according to claim 7, wherein, if there are a plurality of distributing rollers, said distributing rollers are drivable independently of one another.

12. The apparatus according to claim 7, wherein the at least one distributing roller is drivable in both directions of rotation.

13. The apparatus according to claim 7, wherein receiving spaces of the filling carriage which are adjacent transversely to the displacement stroke of the filling carriage have distributing rollers which can be driven together or separately.

14. The apparatus according to claim 7, wherein the receiving spaces of the filling carriage are formed at least partly in interchangeable housings carrying distributing rollers.

15. The apparatus according to claim 7, wherein the inlet region for concrete mortar is narrowed towards the distributing roller.

16. The apparatus according to claim 7, wherein the distributing roller has webs extending over its length and outwards.

17. The apparatus according to claim 16, wherein the webs are straight.

18. The apparatus according to claim 16, wherein the webs run with varying inclination to the radial direction relative to the distributing roller.

19. The apparatus according to claim 16, wherein the webs run helically along the circumference of the distributing roller.
